(19) United States
(12) Patent Application Publication
(10) Pub. No.: US 2023/0377030 A1
(43) Pub. Date: Nov. 23, 2023

(54) METHOD AND APPARATUS FOR REMOTELY PURCHASING NON-FUNGIBLE PRODUCTS WITH HOME DELIVERY

(71) Applicant: E_COMMERCE 4.0 S.R.L., Lizzanello (LE) (IT)

(72) Inventor: MAURIZIO SCHIPA, OZZANO DELL'EMILIA (IT)

(21) Appl. No.: 18/246,779

(22) PCT Filed: Sep. 28, 2021
(86) PCT No.: PCT/IB2021/058853

§ 371 Date: Mar. 27, 2023

(30) Foreign Application Priority Data
Sep. 29, 2020 (IT) 102020000022927

(51) Int. Cl. G06Q 30/0601; G06Q 10/083; G06Q 30/018

(52) U.S. Cl. CPC G06Q 30/0643; G06Q 10/083; G06Q 30/0185

(57) ABSTRACT

A method for remotely purchasing non-fungible products with home delivery comprises the step of providing an image acquisition system at a point of sale. The method further comprises the step of supplying to a remote user via the acquisition system the images in real time of a plurality of non-fungible products which are present at the point of sale, and the step of acquiring at the point of sale an indication of selection by the remote user, which is associated with at least one non-fungible product included in the plurality of non-fungible products which are present in the images supplied to the remote user. The method further includes the step of uniquely and non-detachably labelling the at least one non-fungible product selected by uniquely identifying it in real time after confirmation by the remote user, and the step of packing the at least one non-fungible product which has been uniquely labelled in a sealed packaging for delivery of the product to the home of the remote user without any changes of identity and uniqueness. An image acquisition apparatus may be integrated in a product display counter and may be connected to a processing node which interacts with a remote terminal for uniquely selecting a non-fungible product.

### FIELD OF THE INVENTION

The present invention generally relates to the sector of remote purchases with home delivery.

The invention is particularly directed towards the remote purchase of non-fungible products with home delivery. The term “non-fungible products” is intended to be understood to be products which are unique in terms of their identity and which cannot be replaced by another product, even one of the same type.

The invention has been developed with particular regard, though not exclusively, for the remote purchase with home delivery of non-fungible food products, mainly fish and meat, but also fruit and vegetables. However, the invention may also be applied to non-fungible products which are not intended to be food, such as, for example, plants and flowers, precious objects, objects of art, antiques or second-hand objects, etc.

### TECHNOLOGICAL BACKGROUND

In the course of the present description, there will be used as examples of non-fungible products seafood products which are sold at the counter of a fishmonger or a supermarket, even if the invention is not excluded from being able to be used in relation to non-fungible products of a different type, as indicated above.

On the counters of fishmongers, there are displayed for sale a large number of examples of the same species of seafood (bream, sea bass, salmon, mullet, turbot, octopus, etc.), each of which is different from the others as a result of the individual characteristics thereof in terms of weight, colour, freshness, etc. Generally similar considerations apply to the types of meat sold at the counters of the butcher's sections, and to other products, both of the food type and of other types, as indicated above.

The practice of making remote purchases via computers over the internet, including for food products, has also undergone a substantial acceleration as a result of the regulations introduced following the COVID-19 pandemic, which limited the movements of persons previously, and has introduced personal distancing criteria which tend to limit gatherings.

The solutions adopted for making remote purchases broadly follow the model introduced at the start of 2000, at the beginnings of e-commerce. Currently, many suppliers have activated for their own clients the home delivery service of food products (“Food Delivery”). By means of a mobile application or remote access by means of computer, a user can select the trusted supplier and, after initially registering, can access a photographic database which allows the products available from this supplier to be displayed. The user selects the product or products which it is desirable to purchase, generating a purchase list which is often identified as a “basket”, often also being able to define the day and the time at which it is desirable for the products to be delivered to the home address. After checking out, the user obtains a digital receipt of what has been ordered.

The known solutions of Food Delivery have also been adapted to intrinsically non-fungible products, such as fresh fish and meats. In this case, the producer can associate with the generic photographic image of the product the use-by date or the assurance of an expiry in a few days, for example, from 15 to 20 days. The selection of the specific product, either fish or meat, is carried out completely by the supplier, from which the user substantially requests the selection in a trusting manner.

Naturally, the known systems are not always suitable and adequate for all situations. For example, knowledgeable clients and real connoisseurs who are seeking products which are prestigious or in any case of a given quality, are accustomed to purchasing the products in person, carefully verifying specific characteristics thereof involving, for example, weight, colour and dimensions, and could reject the purchase if it had to be based on the simple selection of a photograph of the product, requesting the selection from third parties, for example, the supplier or retailer himself/herself, of a similar product. In the same manner, the users who have not yet built up a trusting relationship with a supplier might not even consider as a matter of principle the purchase of a non-fungible product, as a result of suspicion and fear of receiving a product which does not comply with the individual expectations.

All this is further involved in the context, in which the return of a seafood product or a piece of fresh meat can be, if not impossible, at least very costly, including legal implications in terms of the warranties due for the remote purchases. It is further necessary to consider that the known systems, based on photographic images and written descriptions, are not immune from problems resulting from possible errors, mistakes and misunderstandings, if not actual occurrences of fraud.

### STATEMENT OF INVENTION

An object of the invention is to solve the problems of the prior art by providing a method and an apparatus for remotely purchasing non-fungible products with home delivery which are simple and reliable, ensuring for the purchaser control over the selection and the delivery of the effective product to his/her satisfaction. Another object of the invention is to provide a method and an apparatus which are simple, economical and simple to install and implement. Another object is to provide a method and an apparatus which allow rapid processing of the orders with the rapid fulfilment of the requests by the purchasers.

These objects and other objects and advantages are achieved by a method and an apparatus having the features indicated in the appended claims.

Very briefly, the method of the present invention is based on the fundamental steps of:
providing a remote view in real time of a specific number of non-fungible products, for example, the fish available on the counter of a selected fishmonger;
allowing a client to select at least one specific non-fungible product from the non-fungible products available in the remote view;
ensuring that the at least one non-fungible product which is specifically selected by the client is identified uniquely at the time of removal by the vendor, before it is packed;
ensuring that the at least one non-fungible product which is specifically selected, identified and subsequently packed is delivered without any alterations to the home of the client.

According to a first aspect, there is described below a method for remotely purchasing non-fungible products with home delivery. The method may comprise a step, in which there is provided an image acquisition system at a point of sale. The provision of various acquisition systems at multiple points of sale may provide a varied selection for the users of the system. However, the system is also advantageous if it is provided at a single point of sale in such a manner that a user can remotely purchase non-fungible products without having to move from his/her own home. The method may comprise a step, in which the image acquisition system can supply in real time to a remote user the images of a plurality of non-fungible products which are present at the point of sale. As mentioned above, the non-fungible products may be of various types, even if a particularly advantageous application is in the food sector, particularly for seafood products and butchery products. The method may comprise the step of acquiring at the point of sale an indication of selection by the remote user. The indication of selection can be associated with at least one non-fungible product included among the non-fungible products which are present and which are or can be displayed in the images acquired and supplied to the remote user in real time. The method may further comprise the step of uniquely and non-detachably labelling the at least one non-fungible product selected in such a manner that it can be uniquely identified. The labelling step can be carried out in real time. The labelling can be carried out after confirmation by the remote user. The method may also comprise the step of packing the non-fungible product(s) which has/have been uniquely labelled. The packing may be carried out in a sealed packaging for delivery of the non-fungible product(s) to the home of the remote user without any changes of identity and uniqueness.

According to a particular aspect, the unique and non-detachable labelling may comprise punching the selected product with an anti-fraud system. In particular, the punching can be carried out in such a manner that it is difficult, if not impossible, to dissociate the labelling from the specific product selected without destroying or significantly changing the product itself. In this manner, the remote user has the assurance that the non-fungible product which the user has seen labelled in real time corresponds to the one received at home subsequently.

According to another particular aspect, the step of acquisition of the indication of selection by the remote user may comprise the digital marking of at least one digital image acquired in real time of the at least one non-fungible product. Preferably, but in a non-limiting manner, the digital marking may comprise the processing of the digital image by the remote user. The processed digital image may be displayed, for example, in a synchronized manner, at the point of sale. It is thereby possible for the remote user to precisely select the desired product with an immediate indication for the vendor.

Independently of the digital marking, it is possible for a digital image to be acquired when the remote user has been viewing one or more non-fungible products. The digital image may be archived in a memory, for example, the memory of a remote server which contains the profile of the user. The digital image may be associated with the profile of the user and associated, for example, with an identification of the date of the order and/or purchases and/or product purchased. In this manner, the digital image acquired in real time can be viewed by the remote user who has accessed his/her individual profile, for example, as a reminder of a purchase or to compare the digital image with the product received.

According to another aspect, the step of packing the non-fungible product(s) which is/are labelled may comprise the attachment of a warranty seal. The warranty seal may be non-detachable. The warranty seal may be attached to the exterior of the packaging. The warranty seal may set out at least one unique identification code of the purchase order. The unique code can be transmitted from the point of sale to the remote user at the end of the purchase operations in real time.

The invention also relates to an apparatus for remotely purchasing non-fungible products with home delivery. According to a specific aspect, the apparatus may comprise at least one display surface and one or more cameras. The one or more cameras can be generally capable of framing the entire display surface. A processing node may be operationally connected to the one or more cameras. The processing node can receive accessible images in real time from a remote terminal. The processing node can be programmed to receive indications of selection by such a remote terminal. The indications of selection can be associated with at least one non-fungible product. The non-fungible product can be included in the plurality of non-fungible products framed in at least one of the images acquired by the one or more cameras on the display surface. According to a preferable, though non-limiting, particular aspect, the one or more cameras can be mounted on a display counter incorporating the display surface.

According to another aspect, the processing node can be programmed to generate a unique identification code of the at least one non-fungible product which is associated with the indications of selection received by the remote terminal. The unique code allows error-free identification of the non-fungible product selected by the remote terminal.

According to another aspect, there may be provided a punching device for labelling, in a unique and non-detachable manner, each non-fungible product associated with the indications of selection received by the remote terminal. The punching ensures the uniqueness and the recognisability of the product selected and subsequently delivered to the home.

According to another aspect, it is possible to include a sales terminal which is arranged at the point of sale. The sales terminal can be selectively interactive with the remote terminal, for example, for confirming the operations of selection and unique identification of the non-fungible products.

### BRIEF DESCRIPTION OF THE DRAWINGS

Additional features and advantages will be appreciated from the following detailed description of a preferred embodiment with reference to the appended drawings which are given by way of non-limiting example and in which:

FIG. 1 is a perspective view of a display counter for seafood products incorporating aspects of the present invention;

FIG. 2 is an example of an identification tag for a specific seafood product which can be selected in accordance with elements of the present invention; and

FIG. 3 is a schematic view of a punchable label which can be used to uniquely identify a non-fungible product according to aspects of the present invention.

### DETAILED DESCRIPTION

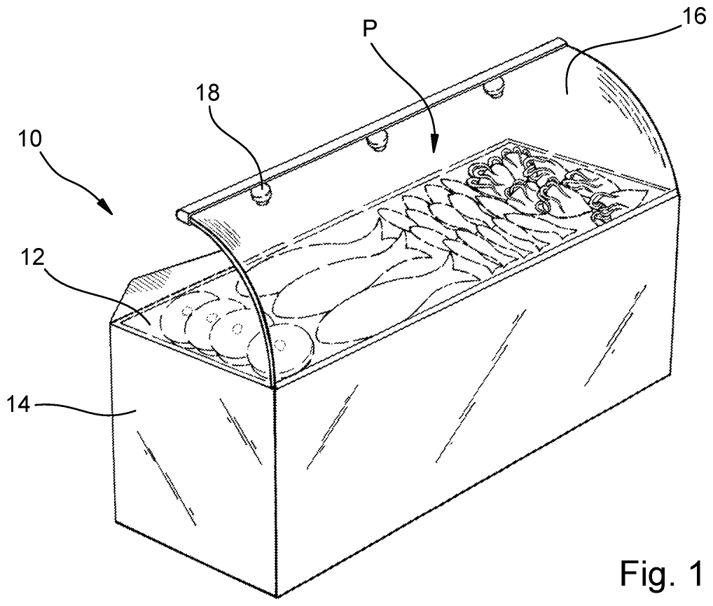

Now with reference to FIG. 1, a display counter 10 for seafood products P comprises a display plane 12 which is supported by a structure 14 of the generally known type. A protection panel 16, for example, made of transparent glass or plexiglass, protects the seafood products at the side directed towards the purchasers. The structure of the display counter 10 may also be of a different type, depending on the types known in the sector of counters for selling food products. One or more cameras 18, preferably but in a non-limiting manner with voice transmission and reception functionality, are placed on the protection panel 16 in such a position as to completely cover with the field of view thereof each portion of the display plane 12, allowing a view of all the seafood products P which are arranged on the display plane. Additionally or alternatively to the protection panel 16, the cameras 18 can be placed on dedicated supports which are mounted on the display counter 10, for example, along the edge of the display plane, and on structures which are separate but near the display counter 10, such as, for example, on the roof or walls of the sales premises. There can be used as the camera 18 any apparatuses which are capable of acquiring images which are sequential over time, such as, for example, a video camera or a camera which is provided to acquire sequential images or any system with similar functionalities.

The cameras 18 may be of the type with a wireless connection or with a wired connection. In the last case, it is advantageous to use a connection of the PoE type (Power over Ethernet) which is capable both of supplying power to the cameras 18 and of transmitting data. The cameras 18 are connected, for example, by means of Ethernet cabled networks or via WiFi or another known data connection system, to a processing node (not illustrated). The processing node may be a tablet, a mobile device, a personal computer, a local or remote server, a cluster of servers, a distributed computing service as in edge computing and/or in the cloud, or any other processing system which generally comprises at least one processor or a group of processors capable of exchanging communications with the cameras 18 or at least processing the images acquired by the cameras 18.

An application which carries out aspects of the method of the precent invention runs on the processing node. The application allows a display of the client who is being served, if he/she exists, the code of the clients waiting to be served, the order of the client who is being served and all the information items necessary for correct fulfilment of the order received. In a state connected to the processing node, there may be provided at least one printer (not illustrated) for printing a label or a ticket with the data necessary for defining the client uniquely, the fishmonger, the number of the order and anything else which is necessary for identifying the operation uniquely.

The processing node can be interrogated by the client via a mobile device, such as a smart phone or a tablet, and/or a computer. According to a preferred but non-limiting method, the user, by accessing the application for the first time, registers by providing a suitable personal profile. Among the various requirements, the system may require the availability concerning the user to allow him/herself to be geolocated so as to set out possible selections for purchase near the individual home. This possibility is particularly advantageous in the case of fresh and perishable food products for which it is preferable to reduce the home delivery times after the product has been selected and packed. Once registered, the user can view a list with all the suppliers, for example, the fishmongers or supermarkets associated and provided with the display counter system 10 described above, by providing, for example, the name, location and photograph(s) thereof.

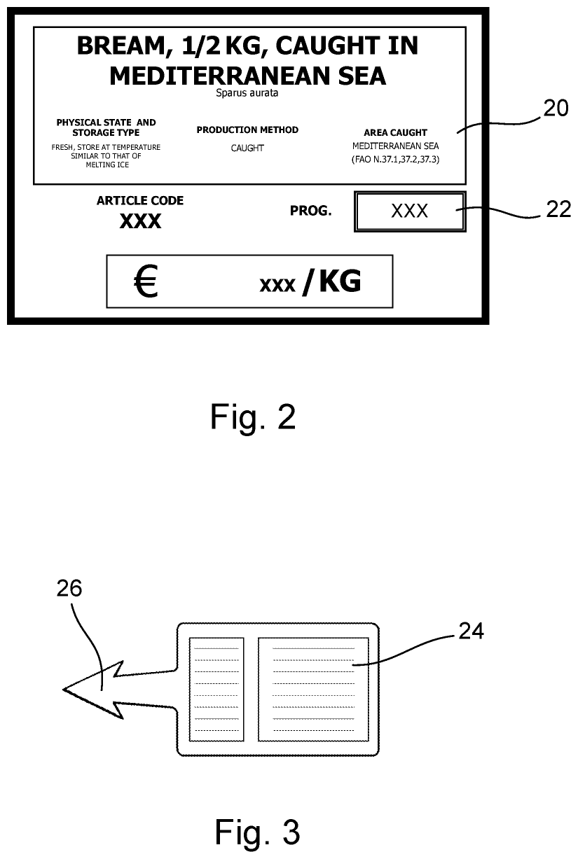

From the application, the user can select a particular supplier, for example, the fishmonger to his/her liking. Once the supplier has been selected, the application will interface with the processing node which is connected to the display counter 10 selected in order to activate the camera(s) 18 present at that location. If there is more than one camera 18, the application can activate the cameras 18 in sequence. Alternatively, the application may set out on a single screen the display of all the cameras 18, from which the user can select one of them in particular in order to enlarge it. Via the camera(s) 18, the user can see whether the product, for example, the seafood product which a given camera 18 is displaying, is the one which he/she desires to buy. By means of the camera 18, the user can view a tag 20 (see FIG. 2) which is placed at the side of the product being observed and which specifies the characteristics of the product itself. In the case of seafood products, the tag 20 is similar to the one already provided by the regulations, on which there is indicated the name, price, FAO provenance (area of capture), the production method (caught, farmed), and the physical state and type of conservation (fresh, previously frozen, etc.). The tag 20 may have an article code and a progressive number 22.

When the user has identified a product which he/she intends to acquire, the operator employed to fulfil the real-time orders of the selected fishmonger will receive on the tablet the request to “start online order” from the user. The operator may confirm to the user the start of the procedure. With confirmation of the start of the procedure, there will be shown to the operator on the tablet exactly what the user sees via the remote terminal. Specifically, both individuals will see in a synchronized manner what is framed by the camera 18 selected by the user at that time. The user is permitted to change the view and camera 18, with the result that the operator will also see what is being framed. The user can select the desired product by sending to the operator a confirmation which indicates the progressive number 22 of the tag 20 which is associated with the product selected, further indicating the quantity of the product required in addition to auxiliary services (cleaning, filleting or the like). The selection of the specific product may be carried out by means of synchronized indication on the image framed by the camera 18, for example, by means of a pointer guided by the user or with a digital marking of an image, such as a video clip or a photographic frame, which is carried out according to methods known in the field of digital image processing. The selection by the user of the progressive number 22 printed on the tag 20 can bring about the taking of a photograph or a video clip by the camera 18 of what is visible, that is to say, of the product identified by the tag 20. The photograph or video clip can be stored in a user area, for example, which is associated with the profile of the user, or sent to the user him/herself who in this case may use it as an acknowledgement of the conformity of the product received, in particular of the colours and shapes thereof, with respect to what was desired and selected. Naturally, there may be provided systems for authenticating the photograph or video clip in order to prevent fraud or in any case errors.

The operator confirms acceptance of the order received in real time to the user. With receipt of “Order accepted”, the tablet of the user and the tablet of the operator simultaneously return to receiving and displaying in real time the images of the camera 18. Therefore, the user can view the hand of the operator which is positioned on the selected product which the operator provides for punching with a unique label 24 (see FIG. 3) directly on the display counter 10. It is possible in this step to use techniques for processing the image in order to simultaneously superimpose on the image of the camera 18, while the operator punches the product P, a display of the data of the order and a unique code which is also set out on the label 24. The punching operation may involve introducing into the head of the fish an arrow 26 which is integral with respect to the label 24 and which is impossible to remove without visibly tearing the head of the fish.

Subsequently, the user can see, in a manner filmed by the camera 18, the hand of the operator which takes from the counter the product which has just been punched in order to position it on the set of scales. This sequence (punching and positioning on the set of scales) is repeated until the weight required by the user is reached and/or for all the products specifically selected by the user by processing the image acquired by the camera 18. After the operator has carried out the optional additional services requested, the products selected are packed in a tray or transport container with a warranty seal for the subsequent transport step and home delivery. The complete fulfilment of the order of the user is concluded with the signalling of “order completed” by the user.

Preferably, every single product selection is followed by the punching and the weighing of the product which is introduced, for example, in a bag. Then, the ticket, which may be of the adhesive type so that it can be used to close the bag after any potential additional services required on the product, is issued. The bag closed by the ticket may therefore be placed in the transport container. In accordance with the quantities and the number of products required by a specific user, there can be prepared a plurality of containers, each of which can be closed by the warranty seal. The warranty seal and/or an auxiliary label can be produced, for example, by a printer which is present at the point of sale. The information items on the warranty seal and/or on the label applied to the transport container may comprise, for example, the unique code, the name of the commercial enterprise (for example, the fishmonger), the time of packaging and sealing, and so on. It is further possible to display on the warranty seal and/or on the label the name of the user, the address thereof and a progressive numerical indicator of the container and the total number of transport containers to be despatched, in order to facilitate the identification and home delivery of the transport containers, preventing errors.

The constituent products of every single order by a user are packed with a seal being attached, for example, an adhesive wrapper, which closes the packaging of the products in a non-removable manner, constituting a warranty seal for the user. Preferably, the seal is printed at the time and also sets out, in addition to the identification data of the product and supplier, the unique code of the order, with the name of the user and the date and time of fulfilment or packing. This allows the user to verify the correspondence of what has been ordered with what is delivered to his/her home, even before opening the packaging. The home delivery of the package is carried out according to one of the methods already in use, particularly in the food sector of Food Delivery, via dedicated delivery agents.

Naturally, the principle of the invention remaining the same, the forms of embodiment and details of construction may be varied widely with respect to those described and illustrated without thereby departing from the scope of the present invention.

1. A method for remotely purchasing non-fungible products with home delivery, comprising the steps of:
providing an image acquisition system at a point of sale;
supplying to a remote user via the acquisition system the images in real time of a plurality of non-fungible products which are present at the point of sale;
acquiring at the point of sale an indication of selection by the remote user, which is associated with at least one non-fungible product included in the plurality of non-fungible products which are present in the images supplied to the remote user;
uniquely and non-detachably labelling the at least one non-fungible product selected by uniquely identifying it with confirmation by the remote user;
packing the at least one non-fungible product which has been uniquely labelled in a sealed packaging for delivery of the product to an address indicated by the remote user without any changes of identity and uniqueness.

2. A method according to claim 1, wherein the unique and non-detachable labelling comprises punching the selected product with an anti-fraud system.

3. A method according to claim 1, wherein the step of acquisition of the indication of selection by the remote user comprises the digital marking of at least one digital image acquired in real time of the at least one non-fungible product.

4. A method according to claim 4, wherein the digital marking comprises the processing of the digital image, by the remote user, which is displayed in a synchronized manner at the point of sale.

5. A method according to claim 1, wherein the step of packing the at least one non-fungible product which is/are labelled comprises the attachment of a warranty seal to the exterior of the packaging, setting out at least one unique identification code of the purchase order, which is transmitted from the point of sale to the remote user at the end of the purchase operations.

6. An apparatus for remotely purchasing non-fungible products with home delivery, comprising at least one display surface (12) and one or more cameras (18) which are generally capable of framing the entire display surface (12), a processing node being operationally connected to the one or more cameras (18) in order to receive accessible images in real time from a remote terminal, the processing node being programmed to receive indications of selection by the remote terminal, which are associated with at least one non-fungible product which is included in the plurality of non-fungible products framed in at least one of the images acquired by the one or more cameras (18).

7. An apparatus according to claim 6, wherein the one or more cameras are mounted on a display counter (10) incorporating the display surface (12).

8. An apparatus according to claim 6, wherein the processing node is programmed to generate a unique identification code of the at least one non-fungible product which is associated with the indications of selection received by the remote terminal.

9. An apparatus according to claim 6, comprising a punching device for labelling, in a unique and non-detachable manner, each non-fungible product associated with the indications of selection received by the remote terminal.

10. An apparatus according to claim 6, including a sales terminal which is arranged at the point of sale and which selectively interacts with the remote terminal for confirming the operations of selection and unique identification of the non-fungible products.
